(19) United States
(12) Patent Application Publication
(10) Pub. No.: US 2026/0076780 A1
(43) Pub. Date: Mar. 19, 2026

(54) DENTAL IMPLANT CROWN AND METHOD TO FABRICATE THEREOF

(71) Applicant: Tae Hyung Kim, La Canada, CA (US)

(72) Inventor: Tae Hyung Kim, La Canada, CA (US)

(73) Assignee: Tae Hyung Kim, La Canada, CA (US)

(21) Appl. No.: 18/885,754

(22) Filed: Sep. 16, 2024

(51) Int. Cl. A61C 8/00; A61C 13/00

(52) U.S. Cl. CPC A61C 8/0016; A61C 13/0006

(57) ABSTRACT

Disclosed is a dental implant crown that includes a front piece, a back piece, and a mechanical interface. The front piece is configured to form a front portion of a tooth morphology. The front piece is made from a material selected from a group including composite, Polymethyl methacrylate (PMMA), and zirconia. The back piece is configured to form a back portion of the tooth morphology. The back piece is made from either polyetheretherketone (PEEK), Titanium, polyaryletherketones (PAEKs), or PEKK (Polyether Ketone Ketone). The mechanical interface is configured to securely hold the front piece and the back piece together to create a complete tooth morphology. The mechanical interface is configured to maintain a structural integrity while allowing the use of different materials for the front piece and back piece to achieve the desired aesthetic and a functional property.

### TECHNICAL FIELD

The presently disclosed embodiments are related, in general, to a dental implant crown. More particularly, the presently disclosed embodiments are related to dental implant crowns and a method for fabricating a dental implant crown.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Polyetheretherketone (PEEK) is a high-performance, semi-crystalline thermoplastic polymer widely recognized for its exceptional mechanical properties, chemical resistance, and biocompatibility. These attributes have led to its use in various medical and dental applications, including as a material for dental implants and frameworks in full-mouth restorations. Despite its advantages, PEEK presents significant challenges in dental restorations, particularly in terms of aesthetics.

One of the primary limitations of PEEK in full-mouth implant restorations is its inherent color, which does not match the natural shade of teeth. PEEK's natural color is opaque and off-white, which can be unappealing when used in visible dental restorations. This mismatch in color and lack of shade adaptability has restricted PEEK's use in areas where aesthetic outcomes are critical, such as in the restoration of anterior teeth.

To address the aesthetic limitations of PEEK, various techniques have been attempted. The most common approach involves completely covering the PEEK framework with composite materials to hide its color. This technique, known as lapping, entails applying layers of composite or other restorative materials over the PEEK to achieve a more tooth-like appearance. However, this method has limitations, including the potential for delamination, difficulty in achieving perfect shade matching, and the inability to customize the appearance to match the patient's natural teeth fully.

In some cases, PEEK has been used solely as an internal structure or framework, completely hidden by external materials like composite or ceramic. While this approach can improve the aesthetic outcome, it fails to leverage the full potential of PEEK as a material and often results in a bulkier restoration, which can be uncomfortable for the patient.

Currently, no successful methods exist for directly coloring PEEK to match the natural shade of teeth, further limiting its utility in aesthetic dental applications. Consequently, the requirement for a dental implant crown that allows for the use of PEEK in full-mouth implant restorations without compromising on aesthetics remains unmet.

Thus, in view of the above, there is a long-felt need in the dental industry to address the aforementioned deficiencies and inadequacies.

Further limitations and disadvantages of traditional approaches will become apparent to one of skill in the art, through the comparison of described systems with some aspects of the present disclosure, as set forth in the remainder of the present application and with reference to the drawings.

### SUMMARY

A dental implant crown and a method for fabricating a dental implant crown are provided substantially, as shown in and/or described in connection with at least one of the figures.

An aspect of the present disclosure relates to a dental implant crown that includes a front piece, a back piece, and a mechanical interface. The front piece is configured to form a front portion of a tooth morphology. The front piece is made from a material either composite, Polymethyl methacrylate (PMMA), or zirconia. The back piece is configured to form a back portion of the tooth morphology. The back piece is made from polyetheretherketone (PEEK), titanium (TT), polyaryletherketones (PAEKs), and PEKK (Polyether Ketone Ketone). The mechanical interface is configured to securely hold the front piece and the back piece together to create a complete tooth morphology. The mechanical interface is configured to maintain structural integrity while allowing the use of different materials for the front piece and back piece to achieve the desired aesthetic and functional property.

In an aspect, the mechanical interface includes interlocking joints on the front piece and the back piece, configured to snap together to form a secure connection.

In an aspect, the front piece is made from zirconia, or other materials capable of achieving natural teeth and gum shade matching.

In an aspect, the back piece is made from PEEK provides mechanical strength and durability.

In an aspect, the front piece covers the visible part of the tooth when installed, and the back piece provides support and attachment to the dental implant crown.

Another aspect of the present disclosure relates to a method for fabricating a dental implant crown. The method includes a step of dividing a tooth morphology into a front piece and a back piece. The method includes a step of forming the front piece from a material selected from a group comprising: composite, Polymethyl methacrylate (PMMA), and zirconia. The method includes a step of forming the back piece from polyetheretherketone (PEEK) material, Titanium, polyaryletherketones (PAEKs), and PEKK (Polyether Ketone Ketone). The method includes a step of creating a mechanical interface on both the front piece and the back piece to allow secure assembly of the front piece and the back piece. The method includes a step of adjusting the material of the front piece to match the natural coloration of a patient's teeth and gums before final assembly with the back piece.

In an aspect, the mechanical interface includes connectors, adhesives, or locking mechanisms to enhance the bond between the front piece and the back piece.

Accordingly, one advantage of the present invention is that it provides an improved method and system for achieving full-mouth implant restorations using PEEK (polyetheretherketone) material in combination with other materials to overcome limitations related to color matching and aesthetic appeal.

These and other features and advantages of the present disclosure may be appreciated from a review of the following detailed description of the present disclosure, along with the accompanying figures in which reference numerals refer to like parts throughout.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a perspective view of the dental implant crown, in accordance with at least one embodiment.

FIG. 2 illustrates an assembled view of the dental implant crown, in accordance with at least one embodiment.

FIG. 3 illustrates a perspective view of the interlocking joints between the front piece and the back piece, in accordance with at least one embodiment.

FIG. 4 is a flowchart of a method for fabricating a dental implant crown, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the apparatuses, methods, and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The present disclosure provides a system that divides dental implant restoration into two distinct pieces. This approach allows for the use of PEEK as the internal framework, while the outer, visible portion is made from a different material such as composite, PMMA (polymethyl methacrylate), or zirconia that can be perfectly shade-matched to the patient's natural teeth. By separating the functional and aesthetic components, this invention offers a superior solution that combines the strength and biocompatibility of PEEK with the aesthetic versatility of other dental materials. This dual-material approach not only solves the problem of shade matching but also enhances the durability and functionality of the implant restoration, providing a more natural appearance and a better overall patient experience.

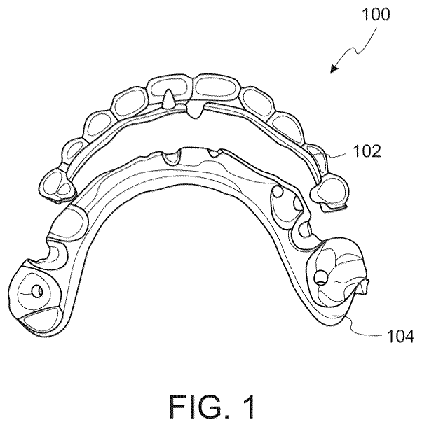

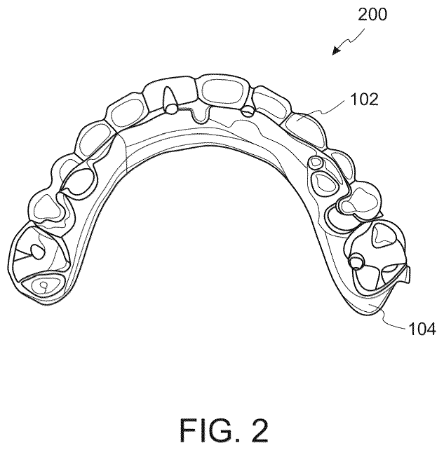

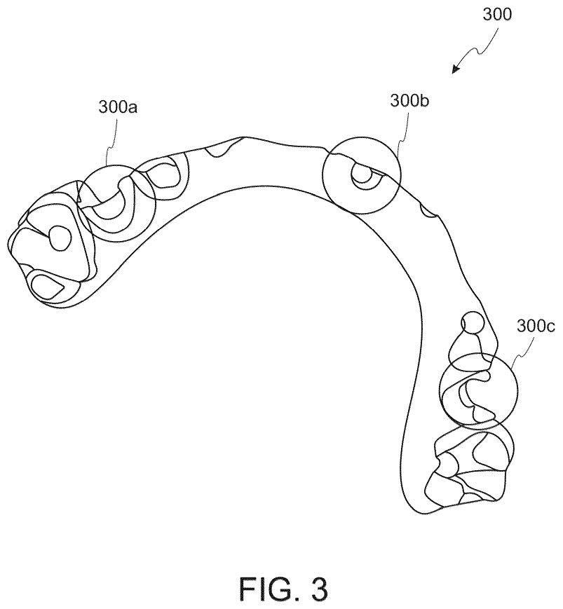

FIG. 1 is a perspective view of a dental implant crown 100, in accordance with at least one embodiment. FIG. 2 illustrates an assembled view of the dental implant crown 100, in accordance with at least one embodiment. FIG. 2 and FIG. 1 are explained in conjunction with each other. The dental implant crown 100 includes a front piece 102, a back piece 104, and a mechanical interface 300 (shown in FIG. 3). The front piece 102 is configured to form a front portion of a tooth morphology. The front piece 102 is made from a material either composite, Polymethyl methacrylate (PMMA), or zirconia. The back piece 104 is configured to form a back portion of the tooth morphology. The back piece 104 is made from polyetheretherketone (PEEK), titanium (TT), polyaryletherketones (PAEKs), and PEKK (Polyether Ketone Ketone), or any other suitable polymers. The mechanical interface 300 is configured to securely hold the front piece 102 and the back piece 104 together to create a complete tooth morphology enabling the use of different materials for the front and back pieces. The mechanical interface 300 is configured to maintain structural integrity while allowing the use of different materials for the front piece 102 and back piece 104 to achieve the desired aesthetic and functional property. In an embodiment, the front piece 102 is made from zirconia providing an enhanced aesthetic appearance. In an embodiment, the back piece 104 is made from PEEK provides mechanical strength and durability. In an embodiment, the front piece 102 covers the visible part of the tooth when installed, and the back piece 104 provides support and attachment to the dental implant crown.

FIG. 3 illustrates a perspective view of the interlocking joints 300a, 300b, and 300c between the front piece 102 and the back piece 104, in accordance with at least one embodiment. FIG. 3 is explained in conjunction with FIGS. 1-2. In an embodiment, the mechanical interface 300 includes interlocking joints 300a, 300b, and 300c on the front piece 102 and the back piece 104, configured to snap together to form a secure connection. Interlocking joints 300a, 300b, and 300c of front piece 102, and back piece 104 are located within teeth shapes. In an embodiment, the interlocking joints 300a, 300b, and 300c are of T taper shape. In implementation, the mechanical interface 300 is designed to provide a secure and reliable connection between the front piece 102 and the back piece 104 of the device. This interface includes multiple interlocking joints, specifically identified as 300a, 300b, and 300c, strategically positioned on both the front piece 102 and the back piece 104. These interlocking joints are configured to snap together, forming a robust and stable connection that resists separation under normal usage conditions. The interlocking joints 300a, 300b, and 300c are embedded within teeth-like structures on the corresponding edges of the front piece 102 and the back piece 104. The teeth shape not only enhances the alignment of the two pieces during assembly but also provides additional mechanical interlocking, which further strengthens the connection.

In a specific embodiment, the interlocking joints 300a, 300b, and 300c feature a T-taper shape. This T-taper configuration is designed to enhance the snap-fit mechanism by providing a tapered interface that allows for easy insertion during assembly while preventing unintentional disassembly. The tapering also facilitates a gradual increase in frictional engagement as the pieces are pressed together, thereby ensuring a tight and secure fit once fully assembled. The choice of the T-taper shape for the interlocking joints is particularly advantageous in applications where a combination of ease of assembly and the strength of the connection is crucial. This design allows the front piece 102 and the back piece 104 to be assembled with minimal effort while providing a connection that remains secure during operation, even in environments subject to vibrations or mechanical stress. Thus, the mechanical interface 300 with interlocking joints 300a, 300b, and 300c, as described, provides a reliable and durable connection between the front piece 102 and the back piece 104. The use of teeth-shaped structures and T-taper-shaped joints ensures that the assembled device maintains structural integrity and resists unintended separation.

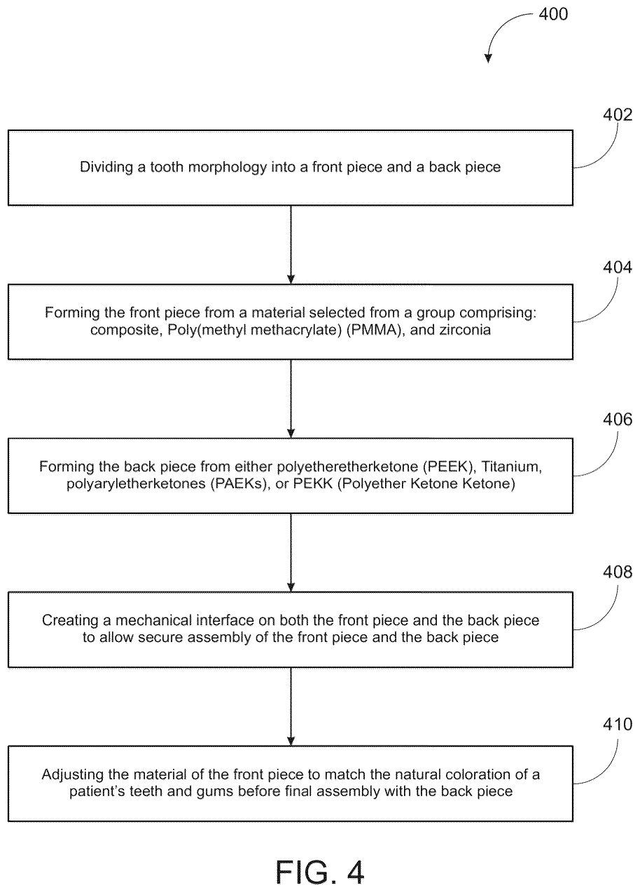

FIG. 4 is a flowchart of a method 400 for fabricating a dental implant crown, in accordance with at least one embodiment. Method 400 includes step 402 of dividing a tooth morphology into a front piece and a back piece. Method 400 includes step 404 of forming the front piece from a material. This material is selected from a group including composite, Polymethyl methacrylate (PMMA), and zirconia. Method 400 includes step 406 of forming the back piece made from polyetheretherketone (PEEK) material, titanium (TT), polyaryletherketones (PAEKs), and PEKK (Polyether Ketone Ketone). Method 400 includes step 408 of creating a mechanical interface on both the front piece and the back piece to allow secure assembly of the front piece and the back piece. Method 400 includes step 410 of adjusting the material of the front piece to match the natural coloration of a patient's teeth and gums before final assembly with the back piece. In an embodiment, the mechanical interface includes connectors, adhesives, or locking mechanisms to enhance the bond between the front piece and the back piece. In an exemplary embodiment, the method includes the step of testing the assembled tooth morphology for fit and comfort before final installation in a patient's mouth.

By dividing the full anatomy of the tooth into a front piece and a back piece, the invention allows the front piece, which is visible to others, to be made from materials specifically selected for their ability to replicate the natural colors of teeth and gums. This results in a more natural and aesthetically pleasing appearance compared to traditional methods where PEEK was either fully lapped with composite materials or hidden entirely.

Further, the present invention enables the use of PEEK in implant crowns, a material previously considered unsuitable for aesthetic dental applications due to its color limitations. By allowing the front piece to be made from different materials such as composite, PMMA, or zirconia, the invention leverages PEEK's mechanical properties and biocompatibility while overcoming its aesthetic drawbacks.

Additionally, the use of different materials for the front piece allows for precise shade matching with the patient's natural teeth and gums. This customization ensures that the implant restoration blends seamlessly with the surrounding teeth, providing a more natural look and enhancing patient satisfaction.

Further, the present invention introduces a new application for PEEK in dental restorations by using it as the structural component in a two-piece design. This innovative approach expands the use of PEEK in implant crowns, offering the dental industry a new material option that combines strength, durability, and biocompatibility with improved aesthetic potential.

The division of the tooth into a front and back piece allows for the integration of PEEK's superior mechanical properties in the back piece, where strength and durability are critical, while the front piece focuses on aesthetic appeal. This dual approach ensures that the restoration is both functionally robust and visually appealing.

With the present invention, PEEK can now be used in a broader range of dental restorations, including full-mouth implant restorations, which were previously limited due to the material's color. This expands the potential applications of PEEK in the dental industry, offering a new solution for both practitioners and patients.

A person skilled in the art will understand that the dental implant crown and the method for fabricating a dental implant crown are described herein for illustrative purposes and should not be construed to limit the scope of the disclosure.

A person with ordinary skills in the art will appreciate that the systems and methods have been illustrated and explained to serve as examples and should not be considered limiting in any manner. It will be further appreciated that the variants of the above-disclosed system elements, modules, and other features and functions, or alternatives thereof, may be combined to create other different apparatuses, systems, or applications.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

I/We claim

1. A dental implant crown, comprising:
a front piece configured to form a front portion of a tooth morphology, wherein the front piece is made from a material selected from a group comprising: composite, Polymethyl methacrylate (PMMA), and zirconia;
a back piece configured to form a back portion of the tooth morphology, wherein the back piece is made from one or more of polyetheretherketone (PEEK), Titanium, polyaryletherketones (PAEKs), and PEKK (Polyether Ketone Ketone); and
a mechanical interface configured to securely hold the front piece and the back piece together to create a complete tooth morphology, wherein the mechanical interface is configured to maintain a structural integrity while allowing the use of different materials for the front piece and back piece to achieve a desired aesthetic and a functional property.

2. The dental implant crown of claim 1, wherein the mechanical interface comprises interlocking joints on the front piece and the back piece, configured to snap together to form a secure connection.

3. The dental implant crown of claim 1, wherein the front piece is made from zirconia provides an enhanced aesthetic appearance.

4. The dental implant crown of claim 1, wherein the back piece is made from PEEK provides mechanical strength and durability.

5. The dental implant crown of claim 1, wherein the front piece covers the visible part of the tooth when installed, and the back piece provides support and attachment to the dental implant crown.

6. A method for fabricating a dental implant crown, the method comprising:
dividing a tooth morphology into a front piece and a back piece;
forming the front piece from a material selected from a group comprising: composite, Polymethyl methacrylate (PMMA), and zirconia;
forming the back piece from one or more of: polyetheretherketone (PEEK), Titanium, polyaryletherketones (PAEKs), and PEKK (Polyether Ketone Ketone); and
creating a mechanical interface on both the front piece and the back piece to allow secure assembly of the front piece and the back piece.

7. The method of claim 6, further comprises the step of adjusting the material of the front piece to match the natural coloration of a patient's teeth and gums before final assembly with the back piece.

8. The method of claim 6, wherein the mechanical interface comprises one or more connectors, adhesives, or locking mechanisms to enhance the bond between the front piece and the back piece.
